(19) United States
(12) Patent Application Publication
(10) Pub. No.: US 2005/0249428 A1
(43) Pub. Date: Nov. 10, 2005

(54) Method of weeding out repeating patterns from programs

(76) Inventor: Ming-Jun Chen, Tai Nan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/973,477

(22) Filed: Oct. 26, 2004

(30) Foreign Application Priority Data
May 7, 2004 (TW) 93112986
May 7, 2004 (CN) 9320948010.

(51) Int. Cl. H04N 5/14

(52) U.S. Cl. 382/254; 348/701

(57) ABSTRACT

A method of weeding out repeating patterns, such as commercials, from programs comprises the steps of obtaining at least one data section from an input source, analyzing the data section to find out at least one repeating pattern and automatically tagging each repeating pattern as a video pattern, saving a new video pattern in a video database, executing a post-process procedure for all video patterns in the data section, and executing an output procedure for the data section.

### BACKGROUND OF THE INVENTION

1. Field of the Invention

The present invention relates to a method of weeding out repeating patterns from programs, and more particularly, to a method for weeding out video sections, such as commercials, by characterizing repeating patterns and using a video database to save the video sections.

2. Descriptions of Prior Arts

Generally, commercial providers have a symbiotic relationship with TV program providers. They purchase a period of time from TV program providers for inserting commercials during the broadcasting of programs in exchange for the exposure of their products or services. These commercials usually accompany a message, such as “Please wait, we'll be right back” or “Welcome back”, shown before interrupting or reentering the main program for indicating interruption or reentry to the main program.

However, most viewers prefer programs without any commercial interruptions, or don't change to a commercial section, especially when watching movies. Moreover, when viewers plan to record a program, such as a TV program or a movie, the recorded video still retains annoying commercial or other repeating sections. Therefore, there is a need in the industry to provide a method of weeding out repeating patterns by learning the character of repeating pictures.

### SUMMARY OF THE INVENTION

It is therefore a primary objective of the present invention to provide a method of weeding out repeating patterns by learning the character of repeating pictures.

In accordance with the claimed invention, a method of weeding out repeating patterns, such as commercials or repeating audio or image patterns, from programs comprises the steps of obtaining at least one data section from an input source, analyzing the data section to find out at least one repeating pattern and automatically tagging each repeating pattern as a video pattern, saving a new video pattern in a video database, executing a post-process procedure for all video patterns in the data section, and executing an output procedure for the data section.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is an operational flow chart illustrating a first embodiment according to the present invention; and

FIG. 2 is an operational flow chart illustrating a second embodiment according to the present invention.

### DETAILED DESCRIPTION OF THE PREFERRED EMBODIMENTS

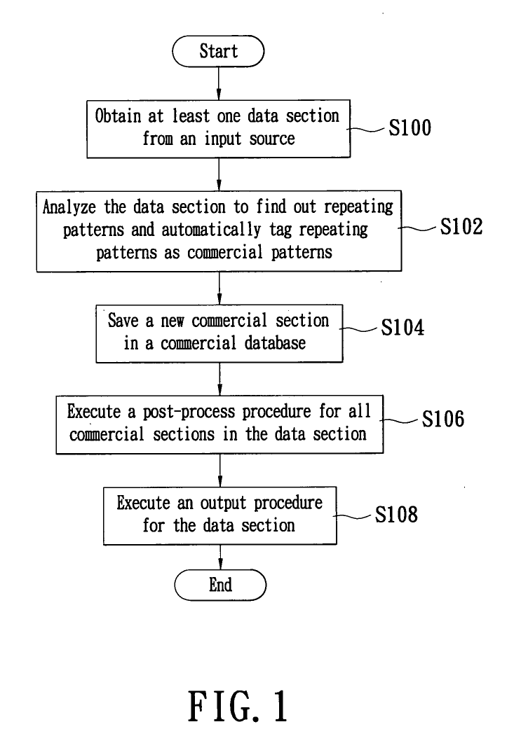

Reference is made to FIG. 1, which is an operational flow chart of a first embodiment according to the present invention. In this embodiment, the method of weeding out repeating patterns from programs firstly obtains at least one data section from an input source (S100). The input source is preferably a video or a television program, and the data section is a video file of the video or a video file of the television program. Please note that the input source preferably includes both audio data and image data. Next, the data section is analyzed to find out repeating patterns which will be automatically tagged as video patterns (S102). Because the input source include both audio data and image data, the input section can be analyzed according to either the audio data or the image data, or according to both of the audio and image data. Each video pattern comprises a start tag and an end tag, and each video pattern is a commercial section, or other repeating audio or image patterns.

The method then saves a new video pattern in a video database (S104). In this embodiment, the video database is a commercial database, and the video pattern is a commercial section. Please note that in step S104, the commercial database saves both the commercial section found in step S102 and the new commercial section analyzed in step S104. A post-process procedure is then executed for all commercial sections in the data section (S106), wherein the post-process procedure is to delete the repeating video patterns. Finally, an output procedure is executed for the data section in order to output a continuous and commercial-free program or video (S108).

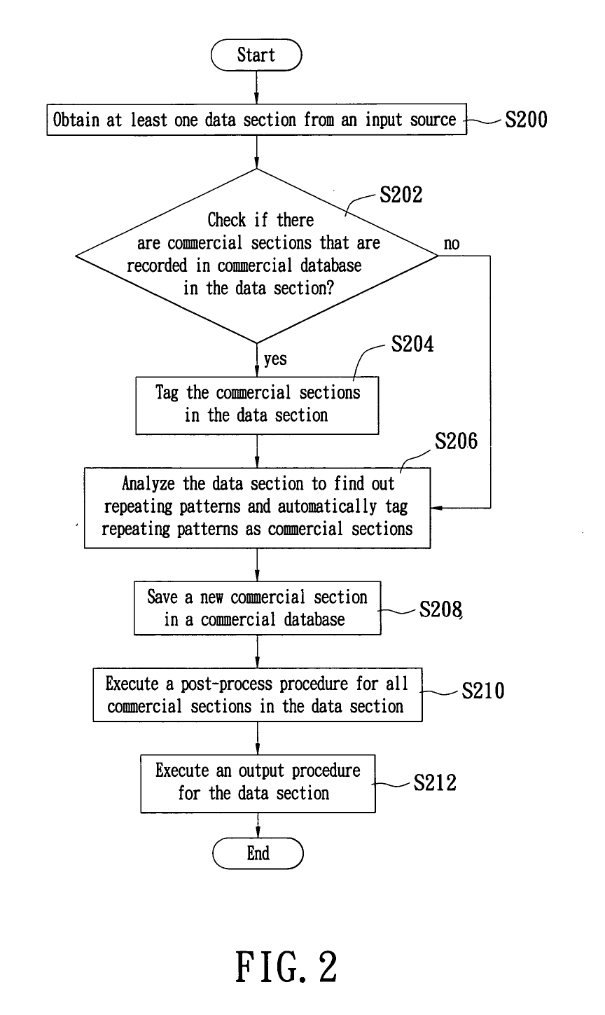

Reference is made to FIG. 2 of an operational flow chart of a second embodiment of the present invention. This embodiment firstly obtains at least one data section from an input source (S200). The input source is preferably a video or television program, and the data section is a video file of the video or a video file of the television program. And the input source preferably includes both audio data and image data. If any one pattern in the data section is identical to any one video pattern saved in a video database (S202), then these identical patterns in the data section would be tagged as commercial sections (S204); otherwise, an analyzing step would be applied to analyze data section to find out repeating patterns and tag them as commercial sections (S206). In this embodiment, each video pattern comprises a start tag and an end tag, the video database is a commercial database, and the video pattern is a commercial section.

Then, those new commercial sections are all saved in the commercial database (S208). A post-process procedure is executed for all commercial sections in the data section (S210), wherein the post-process procedure is to delete the repeating video patterns. Finally, an output procedure is executed for the data section in order to output a continuous and commercial-free program or video (S212).

When data are entered, such as when recording a program, the present invention will automatically check whether a repeating pattern exists in the television program or in the video. After checking the data, the present invention will tag repeating patterns and save them in the video database. The video database will increase when different repeating sections of existence appear in the television program or in the video, and the present invention will automatically learn and save the repeating sections in the database. Those repeating sections can be commercial sections, repeating audio sections, or repeating image sections. Therefore, the present invention is an over-program application.

In the embodiment, the present invention will estimate whether the commercial section is inside the data section in the television or in the video. Many commercial sections exist in the data section. These commercial sections may be present on the commercial database. The present invention recognizes the same commercial sections in other commercial sections. However, the other commercial sections may be not present in the commercial database. The present invention will automatically add the other commercial sections to the commercial database and, when encountering other commercial sections, will recognize them as commercials.

The present invention application layer is not limited to eliminating commercials, the commercial statistics or commercial indices. Other applications of the present invention include finding a key program, a repeating audio pattern, or other repeating image pattern in the records program. The present invention can find a repeating program or pattern for playing or recording, tag the key program and store it in the database. Users can then delete or reserve the tagged program.

Those skilled in the art will readily observe that numerous modifications and alterations of the device may be made while retaining the teachings of the invention. Accordingly, the above disclosure should be construed as limited by the metes and bounds of the appended claims.

1. A method of weeding out repeating patterns from programs, comprising:
obtaining at least one data section from an input source;
analyzing the data section to find out at least one repeating pattern and automatically tagging each repeating pattern as a video pattern; and
executing an output procedure for the data section.

2. The method in claim 1, wherein the input source is a video.

3. The method in claim 1, wherein the input source is a television program.

4. The method in claim 1, wherein the input source comprises audio data and image data.

5. The method in claim 4, wherein the data section is analyzed according to the audio data of the input source.

6. The method in claim 4, wherein the data section is analyzed according to the image data of the input source.

7. The method in claim 1, wherein each video pattern comprises a start tag and an end tag.

8. The method in claim 1, wherein each video pattern is a commercial section.

9. The method in claim 1, wherein the step of analyzing the data section further comprises:
saving a new video pattern in a video database; and
executing a post-process procedure for all repeating video patterns in the data section.

10. The method in claim 9, wherein the post-process procedure is to delete the repeating video patterns.

11. The method in claim 1, wherein the output procedure is to output a continuous program.

12. The method in claim 1, wherein the output procedure is to output video patterns.

13. A method of weeding out repeating patterns from programs, comprising:
obtaining at least one data section from an input source;
analyzing the data section to find out at least one repeating pattern and automatically tagging each repeating pattern as a video pattern;
saving a new video pattern in a video database;
executing a post-process procedure for all repeating video patterns in the data section; and
executing an output procedure for the data section.

14. The method in claim 13, wherein the input source is a video.

15. The method in claim 13, wherein the input source is a television program.

16. The method in claim 13, wherein the input source comprises audio data and image data.

17. The method in claim 16, wherein the data section is analyzed according to the audio data of the input source.

18. The method in claim 16, wherein the data section is analyzed according to the image data of the input source.

19. The method in claim 13, wherein each video pattern comprises a start tag and an end tag.

20. The method in claim 13, wherein the video database is a commercial database, and each video pattern is a commercial section.

21. The method in claim 13, wherein the post-process procedure is to delete the repeating video patterns.

22. The method in claim 13, wherein the output procedure is to output a continuous program.

23. The method in claim 13, wherein the output procedure is to output video patterns.

24. A method of weeding out repeating patterns from programs, comprising:
obtaining at least one data section from an input source;
checking if one pattern in the data section is identical to one video pattern saved in a video database;
tagging each identical pattern in the data section as a video pattern; and
executing an output procedure for the data section.

25. The method in claim 24, wherein the input source is a video.

26. The method in claim 24, wherein the input source is a television program.

27. The method in claim 24, wherein the input source comprises audio data and image data.

28. The method in claim 27, wherein the data section is analyzed according to the audio data of the input source.

29. The method in claim 27, wherein the data section is analyzed according to the image data of the input source.

30. The method in claim 24, wherein each video pattern comprises a start tag and an end tag.

31. The method in claim 24, wherein the video database is a commercial database, and each video pattern is a commercial section.

32. The method in claim 24, wherein in the checking step, if one pattern in the data section is identical to one video pattern saved in the video database, then continuing the tagging step, otherwise analyzing the data section to find out at least one repeating pattern and automatically tagging each repeating pattern as a video pattern.

33. The method in claim 24, wherein the tagging step further comprises:
analyzing the data section to find out at least one repeating pattern and automatically tagging each repeating pattern as a video pattern;
saving a new video pattern in a video database; and
executing a post-process procedure for all video patterns in the data section.

34. The method in claim 24, wherein the output procedure is to output a continuous program.

35. The method in claim 24, wherein the output procedure is to output video patterns.

36. A method of weeding out repeating patterns from programs, comprising:
obtaining at least one data section from an input source;
checking if one pattern in the data section is identical to one video pattern saved in a video database;
tagging each identical pattern in the data section as a video pattern;
analyzing the data section to find out at least one repeating pattern and automatically tagging each repeating pattern as a video pattern;
saving a new video pattern in a video database;
executing a post-process procedure for all video patterns in the data section; and
executing an output procedure for the data section.

37. The method in claim 36, wherein the input source is a video.

38. The method in claim 36, wherein the input source is a television program.

39. The method in claim 36, wherein the input source comprises audio data and image data.

40. The method in claim 39, wherein the data section is analyzed according to the audio data of the input source.

41. The method in claim 39, wherein the data section is analyzed according to the image data of the input source.

42. The method in claim 36, wherein each video pattern comprises a start tag and an end tag.

43. The method in claim 36, wherein the video database is a commercial database, and each video pattern is a commercial section.

44. The method in claim 36, wherein in the checking step, if one pattern in the data section is identical to one video pattern saved in the video database, then continuing the tagging step, otherwise jumping to the analyzing step.

45. The method in claim 36, wherein the output procedure is to output a continuous program.

46. The method in claim 36, wherein the output procedure is to output video patterns.
